(19) United States
(12) Patent Application Publication
(10) Pub. No.: US 2007/0218928 A1
(43) Pub. Date: Sep. 20, 2007

(54) Method and apparatus for acquiring point-to-multipoint MBMS service information in a wireless communications system

(75) Inventor: Richard Lee-Chee Kuo, Taipei City (TW)

Correspondence Address: BIRCH, STEWART, KOLASCH & BIRCH, LLP, 8110 GATEHOUSE ROAD, SUITE 100 EAST, FALLS CHURCH, VA, 22315, US

(73) Assignee: Innovative Sonic Limited

(21) Appl. No.: 11/717,121

(22) Filed: Mar. 13, 2007

Related U.S. Application Data
(60) Provisional application No. 60/767,274, filed on Mar. 15, 2006.

(51) Int. Cl. H04Q 7/20

(52) U.S. Cl. 455/466

(57) ABSTRACT

A method of acquiring information of a point-to-multipoint (p-t-m) Multimedia Broadcast Multicast Service (MBMS) service for a receiving terminal in a wireless communications system includes performing an MBMS Control Channel (MCCH) acquisition procedure when the receiving terminal releases a resource used for receiving the p-t-m MBMS service, or performing an MBMS Control Channel (MCCH) acquisition procedure when a state of a Radio Resource Control (RRC) entity of the receiving terminal changes.

### CROSS REFERENCE TO RELATED APPLICATIONS

This application claims the benefit of U.S. Provisional Application No. 60/767,274, filed on Mar. 15, 2006 and entitled “Method and Apparatus to Determine when to Perform MCCH Acquisition in a Wireless Communications System”, the contents of which are incorporated herein by reference.

### BACKGROUND OF THE INVENTION

1. Field of the Invention

The present invention relates to a method and related apparatus for acquiring point-to-multipoint (p-t-m) Multimedia Broadcast Multicast Service (MBMS) service information, and more particularly, to a method and related apparatus for acquiring p-t-m MBMS service information to increase efficiency and comprehensiveness of reception of a p-t-m MBMS service in a receiving terminal of a wireless communications system.

2. Description of the Prior Art

The third generation (3G) mobile telecommunications system has adopted a Wideband Code Division Multiple Access (WCDMA) wireless air interface access method for a cellular network. WCDMA provides high frequency spectrum utilization, universal coverage, and high quality, high-speed multimedia data transmission. The WCDMA method also meets all kinds of QoS requirements simultaneously, providing diverse, flexible, two-way transmission services and better communication quality to reduce transmission interruption rates. To enhance multimedia functions in the 3G mobile telecommunications system, a protocol specification developed by the 3^{rd} Generation Partnership Project (3GPP) provides Multimedia Broadcast Multicast Service (MBMS). MBMS is a point-to-multipoint bearer service and is established on existing network architecture of the Universal Mobile Telecommunications System (UMTS), utilizing Internet Protocol (IP) packets as a medium. Thus, MBMS allows a single source entity to transmit data to multiple user entities simultaneously.

Since the 3GPP has thoroughly defined operations and architecture of MBMS in the related specifications, the operations and architecture of MBMS are described only briefly hereinafter. For the universal mobile telecommunications system (UMTS), the 3G communications system comprises User Equipment (UE), the UMTS Terrestrial Radio Access Network (UTRAN), and the Core Network (CN). Communications protocols utilized include Access Stratum (AS) and Non-Access Stratum (NAS). AS comprises various sub-layers for different functions, including Radio Resource Control (RRC), Radio Link Control (RLC), Media Access Control (MAC), Packet Data Convergence Protocol (PDCP), and Broadcast/Multicast Control (BMC). The sub-layers mentioned, and their operating principles, are well known in the art, and detailed description thereof is omitted. For MBMS, the Core Network further comprises the Broadcast Multicast Service Center (BM-SC) that is not only a newly added network node but also an entry point for receiving external data, e.g. data provided by a content provider. The BM-SC manages provision, delivery, announcement, authorization, and storage of related parameters for MBMS services, and transmits corresponding information to the Gateway GPRS Support Node (GGSN). In the MBMS system architecture, the GGSN plays a role as an entry point for IP multicast traffic, and routes MBMS data to the Serving GPRS Support Node (SGSN) via a proper GPRS Tunnel (GTP). More than one SGSN can exist under the GGSN. The SGSN performs MBMS Bearer Service control functions to accurately transmit data packets to the UTRAN, allowing multiple UEs, which order the same MBMS service in the same UTRAN to receive the same MBMS data. The SGSN can comprise more than one Radio Network Controller (RNC). The RNCs are responsible for efficiently allocating radio resources for the UEs according to the number of UEs counted by the Node-Bs (NB). The RNC comprises more than one NB that is responsible for transmitting or receiving radio waves to or from the UEs.

According to the protocol specification developed by the 3GPP, MBMS offers two service modes: Broadcast mode and Multicast mode. When interested in a specific MBMS service, the UE needs to order the BM-SC for the MBMS service by establishing a service agreement including service provision phases. These two service modes have different service provision phases in the service agreement. The service provision phase of Broadcast mode includes Service announcement, Session Start, MBMS notification, Data Transfer and Session Stop. The service provision phase of Multicast mode includes Subscription, Service announcement, Joining, Session Start, MBMS notification, Data Transfer, Session Stop and Leaving. For realizing customized services, Joining and Leaving sessions utilized in Multicast mode enable the BM-SC to execute authorization and payment recording for the UEs at the Joining session. The service provision phases mentioned above are well known in the art, and will not be described in detail.

From the standpoint of the RRC, all logical data communication exchange channels, be they for providing data transmission exchange to the UE or for providing RRC layer control signal transmission exchange, are defined in the context of a Radio Bearer (RB). In the UE end, the RB comprises one unidirectional, or a pair of, uplink/downlink logic data transmission exchange channels. In the network end, the RB comprises one unidirectional, or a pair of, uplink/downlink logic data transmission exchange channels.

When providing the MBMS service, the UTRAN may obtain the number of the UEs ordering the MBMS service via a counting procedure, and can adopt either one of the following two transmission modes: point-to-point (p-t-p) transmission and point-to-multipoint (p-t-m) transmission. In the p-t-p transmission, transmission between the UEs and the UTRAN utilizes a dedicated-channel, and thereby the Node-B establishes one dedicated channel for one UE to transmit data and configuration. Compared with the p-t-p transmission, the p-t-m transmission allows the CN to provide the data and the configuration for multiple UEs in the same cell simultaneously. In addition, when the MBMS service is in Broadcast mode, only the p-t-m transmission is used. When the MBMS service is in Multicast mode, the UTRAN switches between the p-t-p and p-t-m transmissions according to the number of UEs. In the protocol specification developed by the 3GPP, three logical channels are defined to transmit corresponding MBMS information: MBMS point-to-multipoint Control Channel (MCCH), MBMS point-to-multipoint Traffic Channel (MTCH), and MBMS point-to-multipoint Scheduling Channel (MSCH). The three logical channels are mapped onto a transport channel, Forward Access Channel (FACH), and the FACH is mapped onto a physical channel, Secondary Common Control Physical Channel (S-CCPCH). MCCH is utilized to transmit a corresponding MBMS configuration, including MBMS Radio Bearer Information, MBMS Service Information, and other information. In general, before obtaining the MBMS configuration, the UE first has to receive System Information block type 5 or 5bis through S-CCPCH, and detect whether MCCH configuration carrying the above-mentioned information is included in the System Information block type 5 or 5bis.

In order for the UE to understand the status of each current MBMS service in which the UE is interested, the RRC specification defines several situations in which the UE is required to perform an MCCH acquisition procedure for receiving the current status of the MBMS services provided in the cell. Thereby, the UEs can activate the service reception or modify the corresponding settings. The situations in which the UE is required to perform the MCCH acquisition procedure include:
1. Upon selecting or re-selecting a cell supporting MBMS services, such as during a power-on period of the UE.
2. Upon change of a cell controlling the MBMS service being received by the UE due to an active set update or hard-handover.
3. Upon entering the UTRAN from another radio access technology (RAT), such as Global System for Mobile Communication (GSM).
4. Upon releasing an MBMS point-to-point radio bearer, such as when transiting from p-t-p transmission to p-t-m transmission in an MBMS service.
5. Upon returning from loss of coverage, such as transiting out of a basement or an elevator, to effective receiving coverage.
6. Upon receiving an indication from upper layers that the MBMS activated service has changed, such as when a new MBMS service item is added into the service set.

In the prior art, the UE is required to perform the MCCH acquisition procedure upon occurrence of the six situations mentioned above, according to the specification, so as to receive real-time information and configuration of the MBMS services efficiently. However, the UE may miss opportunities to receive MBMS services provided, since the UE is not specified to perform the MCCH acquisition procedure under certain situations that are not taken into consideration.

### SUMMARY OF THE INVENTION

It is therefore a primary object of the present invention to provide a method and apparatus of acquiring point-to-multipoint MBMS service information in a wireless communications system.

The present invention discloses a method of acquiring information of a point-to-multipoint (p-t-m) Multimedia Broadcast Multicast Service (MBMS) service for a receiving terminal in a wireless communications system. The method comprises the following step of performing an MBMS Control Channel (MCCH) acquisition procedure when the receiving terminal releases a resource used for receiving the p-t-m MBMS service.

The present invention further discloses a receiving device for providing timely acquisition of information of a point-to-multipoint (p-t-m) Multimedia Broadcast Multicast Service (MBMS) service in a wireless communications system. The receiving device comprises a control circuit, a processor and a memory. The control circuit is used for realizing functions of the receiving device. The processor is installed in the control circuit and is used for executing a program code to operate the control circuit. The memory is coupled to the processor for storing the program code. The program code comprises performing an MBMS Control Channel (MCCH) acquisition procedure when the receiving device releases a resource used for receiving the p-t-m MBMS service.

The present invention further discloses a method of acquiring information of a point-to-multipoint Multimedia Broadcast Multicast Service (MBMS) service for a receiving terminal in a wireless communications system. The method comprises the following step of performing an MBMS Control Channel (MCCH) acquisition procedure when a state of a Radio Resource Control (RRC) entity of the receiving terminal changes.

The present invention further discloses a receiving device for providing timely acquisition of information of a point-to-multipoint Multimedia Broadcast Multicast Service (MBMS) service in a wireless communications system. The receiving device comprises a control circuit, a processor and a memory. The control circuit is used for realizing functions of the receiving device. The processor is installed in the control circuit and is used for executing a program code to operate the control circuit. The memory is coupled to the processor for storing the program code. The program code comprises performing an MBMS Control Channel (MCCH) acquisition procedure when a state of a Radio Resource Control (RRC) entity of the receiving terminal changes.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of a receiving device.

FIG. 2 is a diagram of program code in FIG. 1.

FIG. 3 is a flow chart of a method according to an embodiment of the present invention.

FIG. 4 is a flow chart of a method according to an embodiment of the present invention.

### DETAILED DESCRIPTION

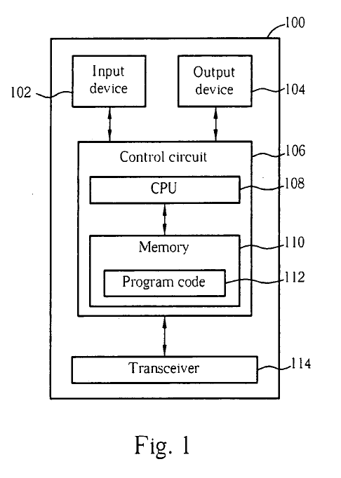

Please refer to FIG. 1, which is a functional block diagram of a receiving device 100. For the sake of brevity, FIG. 1 only shows an input device 102, an output device 104, a control circuit 106, a central processing unit (CPU) 108, a memory 110, a program code 112, and a transceiver 114 of the receiving device 100. In the receiving device 100, the control circuit 106 executes the program code 112 in the memory 110 through the CPU 108, thereby controlling an operation of the receiving device 100. The receiving device 100 can receive signals input by a user through the input device 102, such as a keyboard, and can output images and sounds through the output device 104, such as a monitor or speakers. The transceiver 114 is used to receive and transmit wireless signals, delivering received signals to the control circuit 106, and outputting signals generated by the control circuit 106 wirelessly. From a perspective of a communications protocol framework, the transceiver 114 can be seen as a portion of Layer 1, and the control circuit 106 can be utilized to realize functions of Layer 2 and Layer 3.

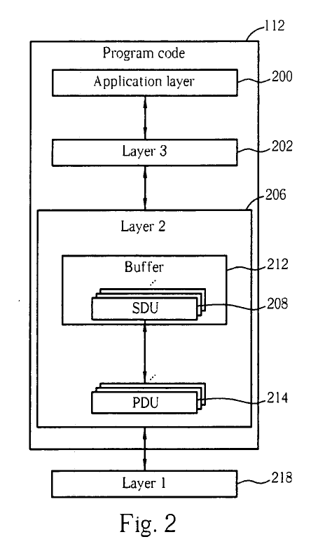

Please continue to refer to FIG. 2. FIG. 2 is a diagram of the program code 112 shown in FIG. 1. The program code 112 includes an application layer 200, a Layer 3 202, and a Layer 2 206, and is coupled to a Layer 1 218. When signals are transmitted, the Layer 2 206 generates multiple serving data units (SDUs) 208 in a buffer 212 based on the data output by the Layer 3 202. The Layer 2 206 generates multiple protocol data units (PDUs) 214 according to the SDUs 208 and further outputs the PDUs 214 to the Layer 1 218 for transmission. On the contrary, when wireless signals are received, the Layer 1 218 is used for receiving the wireless signals, and the received wireless signals are outputted in a format of the PDUs 214 to the Layer 2 206. The Layer 2 206 recovers the PDUs 214 to the SDUs 208 stored in the buffer 212. Finally, the Layer 2 206 transfers the SDUs 208 to the Layer 3 202.

The receiving device 100 receives MBMS service data and configuration in the third generation mobile telecommunications system. The embodiment of the present invention provides the following process for the program code 112 to modify corresponding algorithms so as to acquire p-t-m MBMS service information in a timely manner. And, the receiving device 100 is required to perform an acquisition procedure when two specific situations happen, so as to increase time efficiency and comprehensiveness of reception of the p-t-m MBMS service.

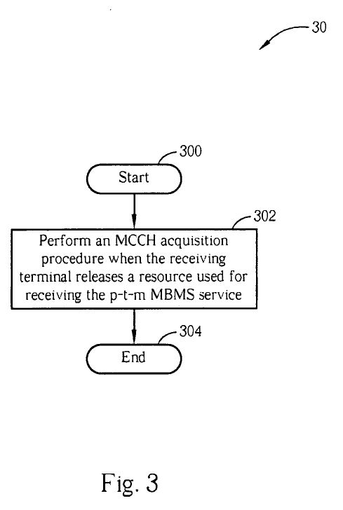

Please refer to FIG. 3, which is a flowchart of a process 30 according to an embodiment of the present invention. The process 30 is utilized to acquire information of a point-to-multipoint (p-t-m) Multimedia Broadcast Multicast Service (MBMS) service in a receiving terminal of a wireless communications system. The process 30 includes the following steps:
Step 300: Start.
Step 302: Perform an MBMS point-to-multipoint Control Channel (MCCH) acquisition procedure when the receiving terminal releases a resource used for receiving the p-t-m MBMS service.
Step 304: End.

According to the process 30, the resource used for receiving the p-t-m MBMS service is/are preferably a p-t-m radio bearer(s) in Step 302. Release of the p-t-m radio bearer(s) by the receiving terminal indicates that the receiving terminal stops receiving the p-t-m MBMS service. For example, assumed that the receiving device 100 receives a broadcast news program. The receiving device 100 should release the corresponding p-t-m radio bearer(s) after the end of the broadcast news program so as to disconnect the radio resource link with the base station. Meanwhile, the receiving device 100 applies the MCCH acquisition procedure to listen to MCCH for corresponding p-t-m MBMS service information, such as MBMS Modified Services Information and MBMS Unmodified Services Information. At the time the receiving terminal releases the p-t-m radio bearer(s), the receiving terminal equipment, such as a mobile phone, does not automatically perform the MCCH acquisition procedure, such that the receiving terminal has no way to know about a current state of p-t-m MBMS services with lower priority. Thus, opportunities to receive the p-t-m MBMS services with lower priority may be lost. To improve this, the receiving terminal is required to perform the MCCH acquisition procedure to obtain information relative to the p-t-m MBMS services with lower priority instantly, such as an on-going status of the news program. Therefore, the embodiment of the present invention can increase time efficiency and comprehensiveness of reception of p-t-m MBMS services for the receiving terminal. Please be noted that there may be multiple MBMS services selected by the user and it is assumed the UE can only receive one MBMS service (i.e. the higher priority one) at a time. After the higher priority MBMS service is released, the lower priority service can then be received.

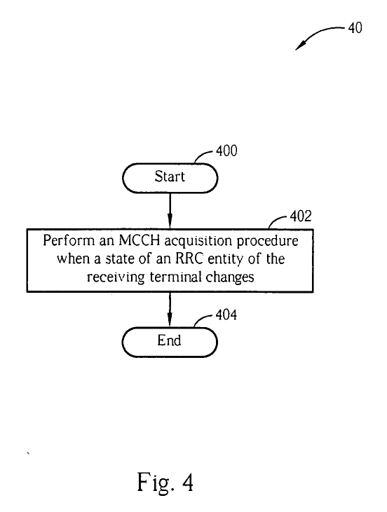

Please refer to FIG. 4, which is a flowchart of a process 40 according to an embodiment of the present invention. The process 40 is utilized to acquire information of a point-to-multipoint Multimedia Broadcast Multicast Service (p-t-m MBMS) service in a receiving terminal of a wireless communications system. The process 40 includes the following steps:
Step 400: Start.
Step 402: Perform an MBMS point-to-multipoint Control Channel (MCCH) acquisition procedure when a state of a radio resource control (RRC) entity of the receiving terminal changes.
Step-404: End.

For the third generation telecommunications system, the RRC specification defines various RRC states to discriminate different usages of radio resources for the User Equipment (UE), which is seen as the receiving terminal in MBMS services. Based on whether an RRC link exists at the UE, the RRC-states can be classified into two groups: RRC disconnection mode, and RRC connection mode. In the RRC disconnection mode, there is no RRC signaling connection established between the UE and the UTRAN. Under this circumstance, the UE operates in Idle mode, such as during a power-on period of the UE for selecting a proper base station. At that moment, the UE can only receive signaling via signaling transmission channels utilized for paging and broadcast. In the RRC connection mode, indicating that there is an RRC signaling connection established between the UE and the UTRAN, four RRC states are defined as: CELL_DCH, URA_PCH, CELL_PCH, and CELL_FACH. CELL_DCH state represents a state in which the UTRAN provides a UE with a dedicated channel, such as during a phoning period of the UE. According to the process 40, a change of the state of the RRC entity of the receiving terminal could be the UE transferring from CELL_DCH state (e.g. phoning) to one of the other states, such as Idle or CELL_PCH state, and thereby the UE performs the MCCH acquisition procedure after transferring to the other RRC state. In the prior art, the receiving terminal may not able to receive the p-t-m MBMS services as well as operating at the CELL_DCH state simultaneously, such that opportunities to request current p-t-m MBMS services provided may be missed. Compared with the prior art, the present invention requires the receiving terminal to perform the MCCH acquisition procedure when the state of the RRC entity of the receiving terminal changes to increase time efficiency and comprehensiveness of reception of the p-t-m MBMS service for the receiving terminal.

Note that the change of the state of the RRC entity of the receiving terminal is not limited to transferring from the CELL_DCH state, and thereby a user can modify the state of the RRC entity according to specifications or communications systems utilized.

To summarize, in the present invention, two newly-added situations requiring the receiving terminal to perform the MCCH acquisition procedure are when the receiving terminal releases the resource of the p-t-m MBMS service on receiving, and when the state of the RRC entity of the receiving terminal changes. Therefore, the receiving terminal can obtain current information corresponding to the p-t-m MBMS service in which the UE is interested, such as current-state of an on-going program, so that the receiving terminal can avoid missing receiving opportunities of the p-t-m MBMS service, and thereby receive the p-t-m MBMS service in as timely and comprehensive a manner as possible.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of acquiring information of a point-to-multipoint (p-t-m) Multimedia Broadcast Multicast Service (MBMS) service for a receiving terminal in a wireless communications system comprising:
performing an MBMS Control Channel (MCCH) acquisition procedure when the receiving terminal releases a resource used for receiving the p-t-m MBMS service.

2. The method of claim 1, wherein the resource of the MBMS service is a p-t-m radio bearer(s).

3. The method of claim 1, wherein the wireless communications system is a third generation mobile telecommunications system.

4. A receiving device for providing timely acquisition of information of a point-to-multipoint (p-t-m) Multimedia Broadcast Multicast Service (MBMS) service in a wireless communications system, the receiving device comprising:
a control circuit for realizing functions of the receiving device;
a processor installed in the control circuit, for executing a program code to operate the control circuit; and
a memory coupled to the processor for storing the program code;
wherein the program code comprises:
performing an MBMS Control Channel (MCCH) acquisition procedure when the receiving device releases a resource used for receiving the p-t-m MBMS service.

5. The receiving device of claim 4, wherein the resource of the MBMS service is/are a p-t-m radio bearer(s).

6. The receiving device of claim 4, wherein the wireless communications system is a third generation mobile telecommunications system.

7. A method of acquiring information of a point-to-multipoint Multimedia Broadcast Multicast Service (MBMS) service for a receiving terminal in a wireless communications system, the method comprising:
performing an MBMS Control Channel (MCCH) acquisition procedure when a state of a Radio Resource Control (RRC) entity of the receiving terminal changes.

8. The method of claim 7, wherein performing the MBMS Control Channel (MCCH) acquisition procedure when the state of the Radio Resource Control (RRC) entity of the receiving terminal changes is performing the MBMS Control Channel (MCCH) acquisition procedure when the state of the Radio Resource Control (RRC) entity of the receiving terminal transits from CELL_DCH state to a first state.

9. The method of claim 8, wherein the first state is Idle Mode.

10. The method of claim 8, wherein the first state is UTRAN Registration Area Paging Channel (URA_PCH) state.

11. The method of claim 8, wherein the first state is CELL_PCH state.

12. The method of claim 8, wherein the first state is CELL_FACH state.

13. The method of claim 8, wherein the wireless communications system is a third generation mobile telecommunications system.

14. A receiving device providing timely acquisition of information of a point-to-multipoint Multimedia Broadcast Multicast Service (MBMS) service in a wireless communications system, the receiving device comprising:
a control circuit for realizing functions of the receiving device;
a processor installed in the control circuit, for executing a program code to operate the control circuit; and
a memory coupled to the processor for storing the program code;
wherein the program code comprises:
performing an MBMS Control Channel (MCCH) acquisition procedure when a state of a Radio Resource Control (RRC) entity of the receiving device changes.

15. The receiving device of claim 14, wherein the program code comprises performing the MBMS Control Channel (MCCH) acquisition procedure when the state of the Radio Resource Control (RRC) entity of the receiving device changes from CELL_DCH state to a first state.

16. The receiving device of claim 15, wherein the first state is Idle Mode.

17. The receiving device of claim 15, wherein the first state is UTRAN Registration Area Paging Channel (URA_PCH) state.

18. The receiving device of claim 15, wherein the first state is CELL_PCH state.

19. The receiving device of claim 15, wherein the first state is CELL_FACH state.

20. The receiving device of claim 14, wherein the wireless communications system is a third generation mobile telecommunications system.
